(19) United States
(12) Patent Application Publication
(10) Pub. No.: US 2007/0032126 A1
(43) Pub. Date: Feb. 8, 2007

(54) HEAT DISSIPATION DEVICE HAVING POWER WIRES FIXTURE

(76) Inventor: Fang-Xiang Yu, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,115

(22) Filed: Mar. 7, 2006

(30) Foreign Application Priority Data
Aug. 5, 2005 (CN) 200520062650.5

(51) Int. Cl. H01R 13/72

(52) U.S. Cl. 439/501

(57) ABSTRACT

A wire fixture (26) for fastening power wires (242) of a heat-dissipating fan (24) to a supporting surface of a heat dissipation apparatus (20). The wire fixture includes a first engaging end (262), a second engaging end (264), and a covering portion (266). The first and second engaging ends are provided with adhesive (27) thereon for being attached to the supporting surface. The covering portion is formed between the first and second engaging ends and without adhesive thereon, for sandwiching the wires of the heat dissipating fan between the wire fixture and the supporting surface of the heat dissipation apparatus.

### FIELD OF THE INVENTION

The present invention relates generally to a heat dissipation device, and particularly to a heat dissipation device having a fixture for attaching power wires of a heat dissipating fan of the heat dissipation device to a heat sink thereof.

### DESCRIPTION OF RELATED ART

A heat dissipation apparatus always includes a heat dissipating fan. In transportation of the heat dissipation apparatus, power wires of the heat dissipating fan needs to be fixed to the heat dissipation apparatus, for facilitating handling of the heat dissipation apparatus during the transportation.

In nowadays, the wires are usually wrapped into a coil which is fixed to the heat dissipation apparatus by a tape with adhesive coated wholly on one of two major surfaces thereof. In fixation of the wires, a middle portion of the tape is adhered to the wires. Then, the wires and the tape are positioned on the heat dissipation apparatus, with two ends of the tape being adhered to the heat dissipation apparatus. Thus, the wires of the heat-dissipating fan are fixed to the heat dissipation apparatus.

In the heat dissipation apparatus, some of the adhesive still sticks to the wires after the tape is peeled off the heat dissipation apparatus. The remained adhesive on the wires may deteriorate the appearance of the wires and contaminate the wires with dusts and dirt. In conventional operation, the remained adhesive needs to be removed from the wires before the heat dissipation apparatus is mounted in a computer, which decreases disassembly efficiency of the heat dissipation apparatus in the computer. Thus, a fixture which can secure power wires of a fan of a heat dissipation apparatus at a fixed position during transportation of the heat dissipation apparatus, and which does not leave adhesive on the wires when the fixture is removed from the wires to release the wires is needed.

### SUMMARY OF INVENTION

The present invention relates to a wire fixture for fastening wires of a heat-dissipating fan to a supporting surface of a heat dissipation apparatus. According to a preferred embodiment of the present invention, the wire fixture includes a first engaging end, a second engaging end, and a covering portion between the two ends. The first and second engaging ends are disposed with adhesive thereon for being adhered to the supporting surface. The covering portion is without adhesive thereon, for urging the wires of the heat dissipating fan to the supporting surface of the heat dissipation apparatus, whereby the wires are fixed in position by the fixture before the fixture is peeled from the supporting surface of the heat dissipation apparatus.

Other advantages and novel features of the present invention will become more apparent from the following detailed description of preferred embodiment when taken in conjunction with the accompanying drawings, in which:

### BRIEF DESCRIPTION OF DRAWINGS

FIG. 1 is an assembled view of a heat dissipation apparatus according to a preferred embodiment of the present invention;

FIG. 2 is a front plane view of a power wire fixture of the heat dissipation apparatus of FIG. 1; and

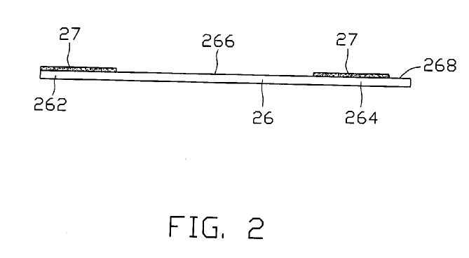

FIG. 3 is a top plane view of the power wire fixture of the heat dissipation apparatus of FIG. 1.

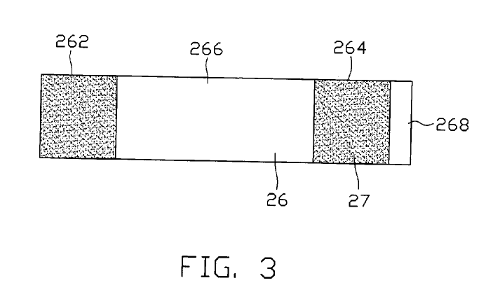

### DETAILED DESCRIPTION

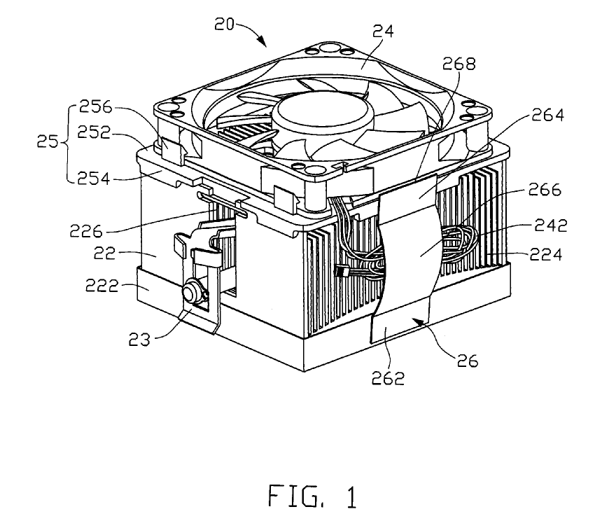

Referring to FIG. 1, a heat dissipation apparatus 20 for timely removing heat generated by a heat-generating electronic component (not shown) includes a heat sink 22 contacting with the heat-generating component, a clip 23 for mounting the heat sink 22 on the heat-generating component, a heat-dissipating fan 24 for driving airflows to pass through the heat sink 22 to take away heat therefrom, a bracket 25 for mounting the heat-dissipating fan 24 onto the heat sink 22, and a wire fixture 26 for attaching power wires 242 of the heat-dissipating fan 24 to the heat dissipation apparatus 20.

The heat sink 22 includes a base 222 thermally contacting with the heat-generating component, and a plurality of fins 224 mounted on the base 222. A channel 226 is defined at a middle portion of the heat sink 22 extending through the fins 224 for receiving the clip 23 therein.

The bracket 25 is sandwiched between the heat sink 22 and the heat-dissipating fan 24. The bracket 25 includes a rectangular shaped main body 252, four clutches 254 extending downwardly near four corners of the main body 252, and four clasps 256 extending upwardly near four corners of the main body 252. The clutches 254 are fastened to two outside fins 224 of the heat sink 22 to mount the bracket 25 on the heat sink 22. The clasps 256 catch the heat-dissipating fan 24 to secure the heat-dissipating fan 24 to the bracket 25, thereby mounting the heat-dissipating fan 24 to the heat sink 22.

The wire fixture 26 is formed as a tape, which is made of elastic material and includes a first and a second engaging end 262, 264 at two ends thereof, respectively. Adhesive 27 is spread on the first and second engaging ends 262, 264 for attaching the wire fixture 26 to the heat dissipation apparatus 20. A covering portion 266 is formed between the first and second engaging ends 262, 264, which does not have adhesive spread thereon. The covering portion 266 is for sandwiching the wires 242 of the heat-dissipating fan 24 between the wire fixture 26 and the heat sink 22 and urging the wires 242 against the heat sink 22. The adhesive 27 does not totally cover the second end 264 of the wire fixture 26, but leaves an extremity of the second end 264 free from the adhesive 17. The extremity forms an operating portion 268 of the wire fixture 26, which is adjacent to the second engaging end 264 and remote from the first engaging end 262. The operating portion 268 is for receiving a force acting thereon to pull the wire fixture 26 off the heat dissipation apparatus 20, after the heat dissipation apparatus is mounted on the heat-generating electronic component secured on a printed circuit board (not shown).

In assembly of the heat dissipation apparatus 20, the clip 23 and the bracket 25 are mounted to the channel 226 and the heat sink 22, respectively. The bracket 25 is depressed toward the heat sink 22 until the clutches 254 attach the bracket 25 onto the heat sink 22. The heat-dissipating fan 24 is mounted to the bracket 25 and received in a space formed between the clasps 256. The heat-dissipating fan 24 is pressed downwardly toward the bracket 25 until the heat-dissipating fan 24 is mounted to the bracket 25 via the clasps 256 engaging with the fan 20. The first engaging end 262 of the wire fixture 26 is attached to a side of the base 222 of the heat sink 22 via the adhesive 27. The wires 242 of the heat-dissipating fan 24 are coiled and put on the side of the heat sink 22 above the first engaging end 262 of the wire fixture 26. Finally, the second engaging end 264 is brought upwardly to be adhered to a side of the main body 252 of the bracket 25 above the wires 242 whereby the wires 242 are sandwiched between the covering portion 266 of the wire fixture 26 and the fins 224 of the heat sink 22. The operating portion 268 extends upwardly beyond the bracket 25 near the fan 24. Thus, the wires 242 are attached to the side of the heat sink 22. The wire fixture 26 is resilient so it exerts a resilient force to the wires 242 to tightly secure the wires 242 of the heat-dissipating fan 24 against the fins 224 at the side of the heat sink 22. Thus, the assembly of the heat dissipation apparatus 20 is accomplished.

In use of the heat dissipation apparatus 20, a force is exerted on the operating portion 268 of the wire fixture 26 to pull the wire fixture 26 off the heat dissipation apparatus 20. So the wires 242 of the heat-dissipating fan 24 is detached from the heat dissipation apparatus 20. Then the heat sink 22 is mounted on the heat-generating electronic component with the clip 23 fastened to a retention module (not shown) surrounding the electronic component, and the power wires 242 are brought to connect with a power socket to drive the fan 24 to rotate.

In the present invention, corresponding surfaces of the heat sink 22, the bracket 25, and the heat-dissipating fan 24 form a supporting surface on the heat dissipation apparatus 20. The wires 242 of the heat-dissipating fan 24 are sandwiched between the covering portion 266 of the wire fixture 26 and the supporting surface of the heat dissipation apparatus 20 via the covering portion 266. The covering portion 266 of the wire fixture 26 contacts with the wires 242 of heat-dissipating fan 24 without adhesive 27 spread thereon. Thus, there will not be adhesive 27 adhered to the wires 242 of the heat-dissipating fan 24 after the wire fixture 26 is peeled off the supporting surface of the heat dissipation apparatus 20. Thus, the wires 242 of the heat-dissipating fan 24 will not be contaminated with dusts and dirt. It is not necessary to clean the wires 242 after the wires 242 are detached from the heat sink 22. Accordingly, the efficiency of mounting of the heat dissipation apparatus 20 to the heat-generating electronic component is increased, in comparison with the conventional art.

In the assembly of the heat dissipation apparatus 20, the first and second engaging ends 262, 264 of the wire fixture 26 are orderly attached to the base 222 of the heat sink 22 and the main body 252 of the bracket 25. Alternatively, the first and second engaging ends 262, 264 of the wire fixture 26 may be attached to the base 222 of the heat sink 22 and the main body 252 of the bracket 25 simultaneously. The second engaging end 264 of the wire fixture 26 may also be attached to other parts of the heat dissipation apparatus 20, such as the fins 224 of the heat sink 22, or the heat-dissipating fan 24.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A wire fixture fastening power wires of a heat-dissipating fan to a supporting surface of a heat dissipation device, the heat dissipation device being for dissipating heat from a heat-generating electronic component, the wire fixture comprising:
first and second engaging ends each disposed with adhesive thereon and attached to the supporting surface; and
a covering portion formed between the first and second engaging ends without adhesive spread thereon and urging the power wires of the heat dissipating fan to the supporting surface.

2. The wire fixture as described in claim 1, further comprising an operating portion adjacent to the second engaging end and remote from the first engaging end, the operating portion being without adhesive thereon.

3. The wire fixture as described in claim 1, wherein the wire fixture is made of elastic material.

4. The wire fixture as described in claim 1, wherein the supporting surface is formed by a side of a heat sink and a side of a fan bracket of the heat dissipation device.

5. The wire fixture as described in claim 4, wherein the first engaging end of the fixture is attached to the heat sink and the second engaging end of the fixture is attached to the fan bracket.

6. A heat dissipation apparatus comprising:
a heat sink;
a heat dissipating fan mounted on the heat sink; and
a wire fixture for attaching wires of the heat dissipating fan to the heat dissipation apparatus, the wire fixture comprising:
a first engaging end disposed adhesive thereon for attaching the wire fixture to one of the heat sink and the heat dissipating fan;
a second engaging end disposed adhesive thereon for attaching the wire fixture to the other one of the heat sink and the heat dissipating fan; and
a covering portion formed between the first and second engaging ends for sandwiching the wires of the heat dissipating fan between the wire fixture and the heat dissipation apparatus, the covering portion being without adhesive thereon.

7. The heat dissipation apparatus as described in claim 6, further comprising a bracket for mounting the heat dissipating fan onto the heat sink.

8. The heat dissipation apparatus as described in claim 7, wherein the heat-dissipating fan is mounted to the heat sink via a plurality of clutches and clasps extending from the bracket.

9. The heat dissipation apparatus as described in claim 6, wherein the heat sink defines a channel for receiving a clip therein.

10. The heat dissipation apparatus as described in claim 6, wherein the wire fixture further comprises an operating portion adjacent to the second engaging end and remote the first engaging end, the operating portion being without adhesive thereon.

11. The heat dissipation apparatus as described in claim 6, wherein the wire fixture is made of elastic material.

12. A heat dissipation apparatus comprising:
a heat sink adapted for absorbing heat from a heat-generating electronic component;
a fan for generating an airflow through the heat sink, the fan having a power wire for electrically connecting with a power; and
a wire fixture for securing the power wire to the heat dissipation apparatus, the wire fixture having a first end and a second end and a covering portion between the first and second ends, the first and second ends being provided with adhesive thereon and being adhered to the heat dissipation apparatus, the covering portion urging the power wire against the heat dissipation apparatus, the covering portion being without adhesive thereon.

13. The heat dissipation apparatus as described in claim 12, further comprising a fan bracket interconnecting the fan and the heat sink, the wire fixture having a configuration of a tape and the first end of the fixture being adhered to the heat sink, the second end of the fixture being adhered to the fan bracket.

14. The heat dissipation apparatus as described in claim 13, wherein the wire fixture further comprises an operation portion adjacent to the second end of the wire fixture and remote from the first end of the wire fixture, the operation portion being located beyond the fan bracket and near the fan, the operation portion being without adhesive thereon.

15. The heat dissipation apparatus as described in claim 14, wherein a portion of the power wire urged by the covering portion of the wire fixture is arranged into a substantially coil configuration.

16. The heat dissipation apparatus as described in claim 13, wherein the heat sink has a base and a plurality of fins extending upwardly from the base, the first end of the wire fixture being adhered to the base and the covering portion of the wire fixture urging the wires against the fins.

17. The heat dissipation apparatus as described in claim 16, wherein the fins define a channel therein, the channel receiving a clip for mounting the heat dissipation apparatus to the heat-generating electronic component.
